(19) United States
(12) Patent Application Publication
(10) Pub. No.: US 2018/0340561 A1
(43) Pub. Date: Nov. 29, 2018

(54) ANGLE CONNECTOR FOR SUPPORTING PROFILES

(71) Applicant: SYMA INTERCONTINENTAL AG, Kirchberg (CH)

(72) Inventor: Kurt ZÜLLIG, Kirchberg SG (CH)

(73) Assignee: SYMA INTERCONTINENTAL AG, Kirchberg (CH)

(21) Appl. No.: 15/989,546

(22) Filed: May 25, 2018

(30) Foreign Application Priority Data
May 26, 2017 (EP) 17 173 061.7

(51) Int. Cl. F16B 7/18

(52) U.S. Cl. CPC F16B 7/182

(57) ABSTRACT

The angle connector (100) has two free ends (110, 120) aligned perpendicular to each other, for the purpose of being inserted into an associated cavity of a supporting profile (10, 20), such that at every free end (110, 120) of the angle connector, a passive means of fixation (131, 132, 133) is provided, via which from one outer side of the supporting profile (10, 20), the respective end of the angle connector can he detachably connected to the associated supporting profile by way of a complementary active fixation element (40, 44). Between the free ends that are aligned perpendicular to each other, a corner element is provided, with profile elements (111, 112) compatible with the supporting profiles provided on its two outer sides that are positioned perpendicular to each other, respectively reaching until the height of the associated surface (55) of the corner element (110).

### TECHNICAL FIELD

The present invention relates to an angle connector with two free ends, aligned perpendicular to each other, for being inserted into a respective cavity of a supporting profiles, each free end of the angle connector being provided with a passive means of fixation, via which from one outer side of the supporting profile, the respective end of the angle connector can be detachably connected to the associated supporting profile by way of a complementary active fixation element.

### PRIOR ART

From DE 20 2014 001 278 U1, an L-shaped angle connector is known, of which the free end is inserted into associated cavities of mitered supporting profiles. In each of the supporting profiles, a respective cavity is provided for receiving the free end of the L-shaped connector. On the interior side of each of the two supporting profiles that are to be perpendicularly connected to each other, a respective screw hole is provided, through which a screw is screwed into a respective correspondingly complementary aperture in the L-shaped connector. Consequently, the profile walls on the front side of the supporting profiles can be butt-jointed with each other at the corner.

From WO 2016/027175, a similar application is known, in which two L-shaped plates are inserted into complementary grooves in the two supporting profiles.

### DESCRIPTION OF THE INVENTION

Departing from this prior art, the task of the invention is to provide an improved corner connector for supporting profiles. The improvement may consist of a manipulation of the screw as a complementary fixation element requiring a smaller rotation. The improvement may further consist of a tightening of the supporting profiles against each other, aside from the mere connection of the supporting profiles. Finally, one advantage of the device according to the invention consists in that the profile connector can be constructed modularly, and finally, the connector can be easily pre-assembled. At the same time, it can take on the full functionality of the two abutting supporting profiles in the corner by way of a corner element.

According to the invention, a corner element is provided between the free ends that are aligned perpendicular to each other, with profile elements compatible with the supporting profiles provided on its two outer sides that are positioned perpendicular to each other, reaching respectively up to the height of the associated surface of the corner element.

The free ends of the angle connector in the portion extending over the corner element may feature a body with a cuboid outer form for form-fitting absorption into a complementary recess in the associated free ends of the supporting profile.

In such cases, it is advantageous when at least one free end of the angle connector features a passive means of fixation in the form of a bolt extending over the cuboid body, which in its cylinder mantle features a conical cavity, the bolt being associated with a sleeve with a cross bore for receiving the bolt and an inner threading at a free end of the sleeve for applying the sleeve on the supporting profile. This allows for tightening the supporting profile against the corner element by means of a locking screw with a conical end that can be screwed into the inner threading. Consequently, the corner connector is not only connected to [the] supporting profile, but the two elements are also interlocked in a direction longitudinal to the direction of the supporting profile, such that the outer surfaces abut each other.

In one alternative, at least one free end of the angle connector is a passive means of fixation in the form of a locking slot with indentations in the cuboid body, associated with a lock arranged in the respective supporting profile. A lock may be embodied, for instance, as [according to] EP 0 871 824, such that by means of an actuator of the lock, [a] locking hook engaging with the indentations can be pulled back, and the supporting profile can be tightened against the corner element. The more elaborate construction of this locking mechanism, which also interlocks the two elements longitudinally to each other in a butt-joint connection, allows for quick locking by rotating the interlock button by less than a full rotation, whereas the more simple sleeve solution usually requires the actuation of the screw head by multiple full rotation[s].

The free ends of the angle connector may be connected to the corner element in a single piece, for instance by welding.

The corner element may feature mounting surfaces on the interior sides located opposite the two perpendicular outer sides[.] For these purposes, two free end pieces are provided, whose end surface[s] placed across from the corner element are designed for being mounted onto the associated mounting surface. Furthermore, fixation elements are provided in order to connect the corner element with the associated free end pieces,

Advantageously, the mounting surfaces then form a cavity for a form-fitting absorption of the end surface.

The profile elements provided on the two perpendicular outer sides form a profile wail surface and a centered slot with indentations, such that the perpendicular profile wall surfaces meet at the corner edge of the corner element. As a result, the respective end surfaces are integrated in a corner element, which allows for more simple and more robust “corners”, which may be replaced as necessary in a manner that is easier than in prior art.

Additional embodiments are described in the dependent claims.

### BRIEF DESCRIPTION OF THE DRAWINGS

Preferred embodiments of the invention are described in the following based on the drawings, which serve solely for clarification and should not be interpreted in a restrictive manner. The drawings show as follows:

FIG. 1 shows a perspective view of a profile connector according to a first exemplary embodiment of the invention;

FIG. 2 shows a perspective view of the profile connector according to FIG. 1 with two profiles, shown in part in cross-section and in part in an exploded view;

FIG. 3 shows a perspective view of a profile connector according to a second exemplary embodiment of the invention;

FIG. 4 shows a perspective view of the profile connector according to FIG. 3 with two profiles, shown in part in cross-section and in part in an exploded view;

FIG. 5 shows a perspective view of a corner element of a profile connector according to a third exemplary embodiment of the invention;

FIG. 6 shows a different perspective view of the corner element according to FIG. 5;

FIG. 7 shows a perspective view of a corner element of a first exemplary embodiment of a profile connector according to a third exemplary embodiment of the invention;

FIG. 8 shows a different perspective view of the connecting arm according to FIG. 7;

FIG. 9 shows a perspective view of a second exemplary embodiment of a connecting arm according to a third exemplary embodiment of the invention; and

FIG. 10 shows a different perspective view of the connecting arm according to FIG. 9.

### DESCRIPTION OF PREFERRED EMBODIMENTS

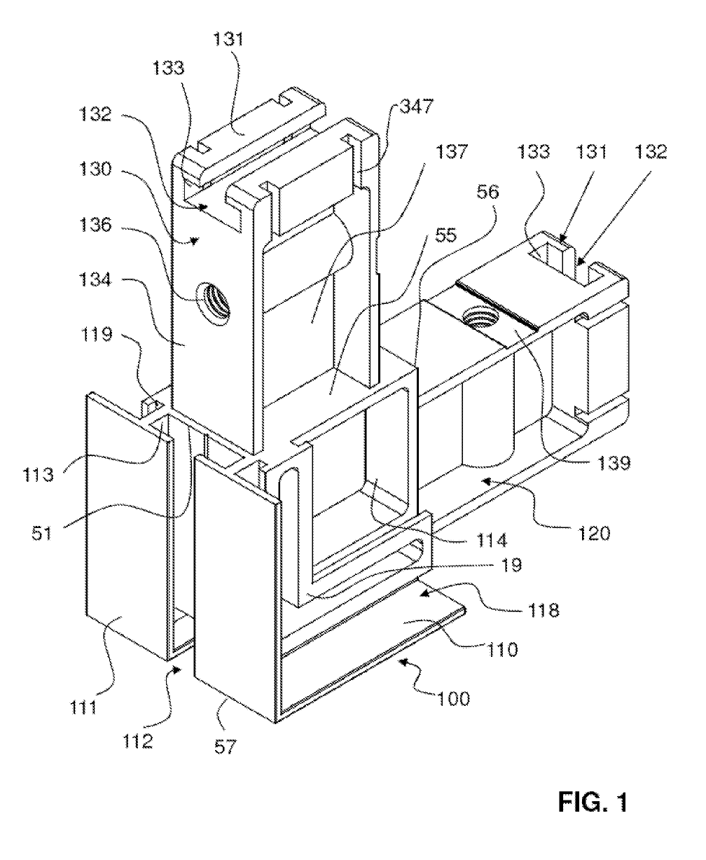

FIG. 1 shows a perspective view of a profile connector 100 according to a first exemplary embodiment of the invention.

The profile connector 100 consists of a corner element 110, a first connecting arm 120, and a second connecting arm 130. In the exemplary embodiment of FIG. 1, these connecting arms 120 and 130 are connected in one piece with the corner element 110 and form its free ends.

The corner element 110 features portions of profile walls 111, which are separated by a centered profile slot 112. These profile walls 111 vertically abut each other at the corner of the corner element 110. Behind the profile slot 112, are lateral indentations 113 are provided, which end in front of the rear wall 52 of the slot in the corner element portion of the central body 114. The slot 112 is provided with indentations 113 for being engaged by locks in order to flange other profiles or additional elements. On that side, underneath the central body 114 of the corner element 110, there is a slot 118 that has a smaller indentation 119 on the central body 114. At the same time, there is an additional small indentation on the opposite side of this L-shaped protrusion 19 of the profile, which is laterally recessed from the front or rear edge of the profile wall 111, however.

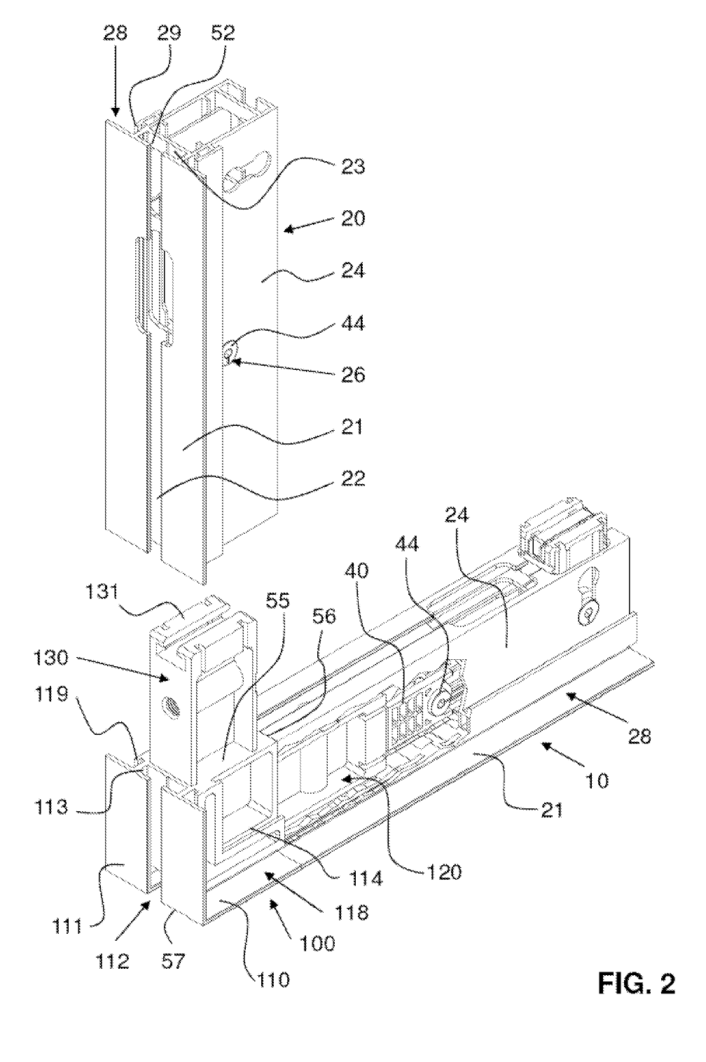

As mentioned above, the second connecting arm 130 connects in one piece to the surface 55 at the corner element 110. The connecting arm 130 is recessed from the rear wall of the slot 52, thereby creating a ledge 51. As will be described hereafter with respect to FIG. 2, in the supporting profile 20, similarly designed connection of the profile wall 21 and the slot 22 can be mounted correspondingly on this profile wall 111 and this slot 112. The opposing innermost portion of the supporting profile 20 arranged close to the edges 56, preferentially abutting it.

In a cross section, the first connecting arm 120, like the second connecting arm 130, essentially has H-shaped walls, specifically two opposing side walls 134, that are connected in the middle by way of the middle wall 137. In the middle wall 137, a sleeve is provided, featuring a continuous transverse screw hole 136, which ends on the opposite side in a cavity 139.

At a free end opposite of the corner element 110, a locking slot is provided, comprising an end surface 131 that is separated from a profile slot 132 dividing this surface, the profile slot widening behind the end surfaces 131 into lateral indentations 133.

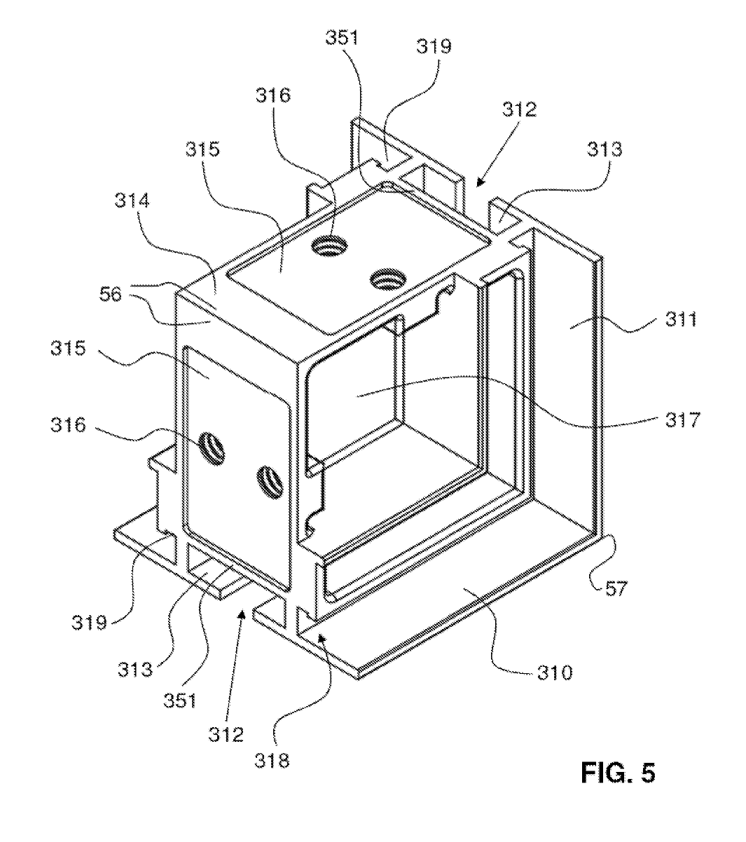

As can be seen in FIG. 1, the first connecting arm 120, which is arranged perpendicular to the second connecting arm 130, is mounted identically to the second connecting arm 130, except that it is mounted on the other free interior side of the corner element 110 and connected to it in one piece. The connection may be by way of adhesion or of welding of the individual components shown in FIGS. 5 through 10. It is material that the supporting profile 10 shown in FIG. 2 abuts the edge 56, such that there, too, it may just touch the other supporting profile 20. The transition is therefore realized at this edge, to the extent that the supporting profiles 10 and 20 in the corner are not standing back.

FIG. 2 describes a perspective view of the profile connector 100 according to FIG. 1 with two profiles, a horizontal supporting profile 10 and a vertical supporting profile 20, shown in part in cross-section and in part in an exploded view. Identical characteristics are referenced in all drawings with the same reference numbers. Similar characteristics, specifically from similar exemplary embodiments, are referenced with similar reference numbers, indicating a functional similarity.

We refer to the ledge 51 on the second connecting arm 130, where, when the vertical profile 20 is shifted onto the second connecting arm 130, an aperture for the second connecting am 130 is provided in the vertical profile 20, the rear wall of the slot 52 sliding directly in front of the front wall of the second connecting arm 130, specifically in a form fit with the other components enclosing it.

The profile wall 21 and the centered profile slot 22 are brought into direct contact with the respective profile walls 1 1 l and profile slots 112 of the corner element 130 as well, such that for the functionality of the supporting profile 20, it transitions seamlessly into the corner element 130 transition and is taken in by it until its end.

With reference to the horizontal supporting profile 10, we refer to the partial cross-section view there, which otherwise features the same elements as the vertical profile 20. In particular, a cross bore 26 through the central body 24 is provided, in which an eccentric locking head 44 is flush or slightly protruding.

The lock 40 with the eccentric locking head 44 that is to be actuated may be one of the many locks known from prior art, specifically a lock by the Applicant, manufactured pursuant to EP 0 871 824. These locks comprise latches that are inserted into the slot 132 due to a rotation of the eccentric locking head, and hook into the indentation 133 and which, by means of a light pull of these hooking elements, also pull the connecting arm 130 in the direction of the on profile that is to be attached.

In the exemplary embodiment of the use of the connecting arm 100 according to FIG. 1, the two profiles 10 and 20 are mounted with their complementary apertures in the central body 24 on the free ends of the first and second connecting arms 120, 130 and shifted forward until the locking elements of the locks 40 used in the, profiles 10 and 20 slide into the slots 132. Through the actuation of the eccentric head 44 by means of a rotation determined by the type of lock, the lock is locked in the slot 13:2, so that the respective supporting profile is in a fixed connection with the L-shaped corner connector 100.

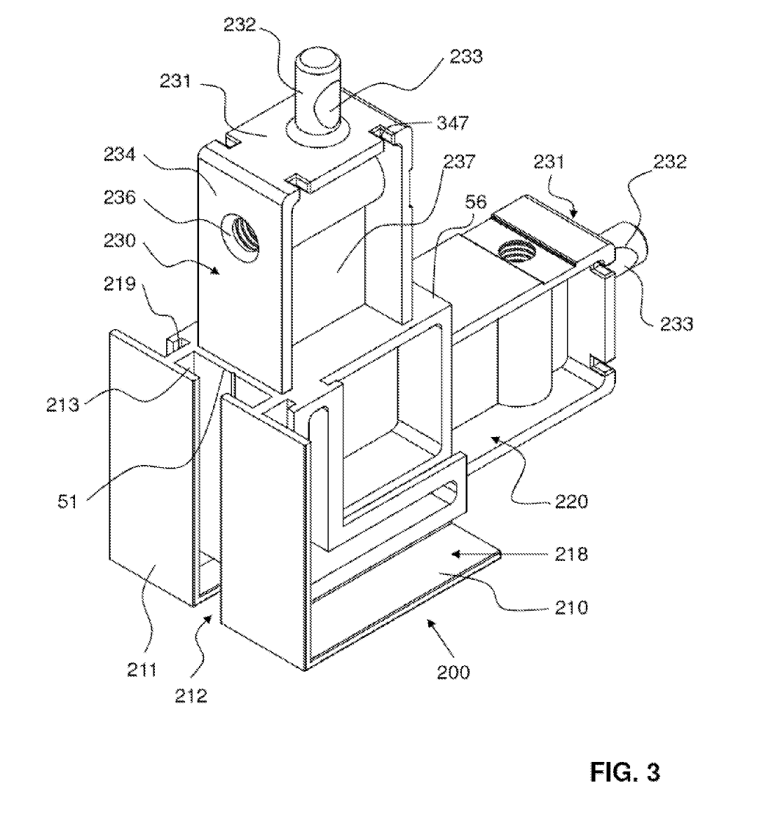

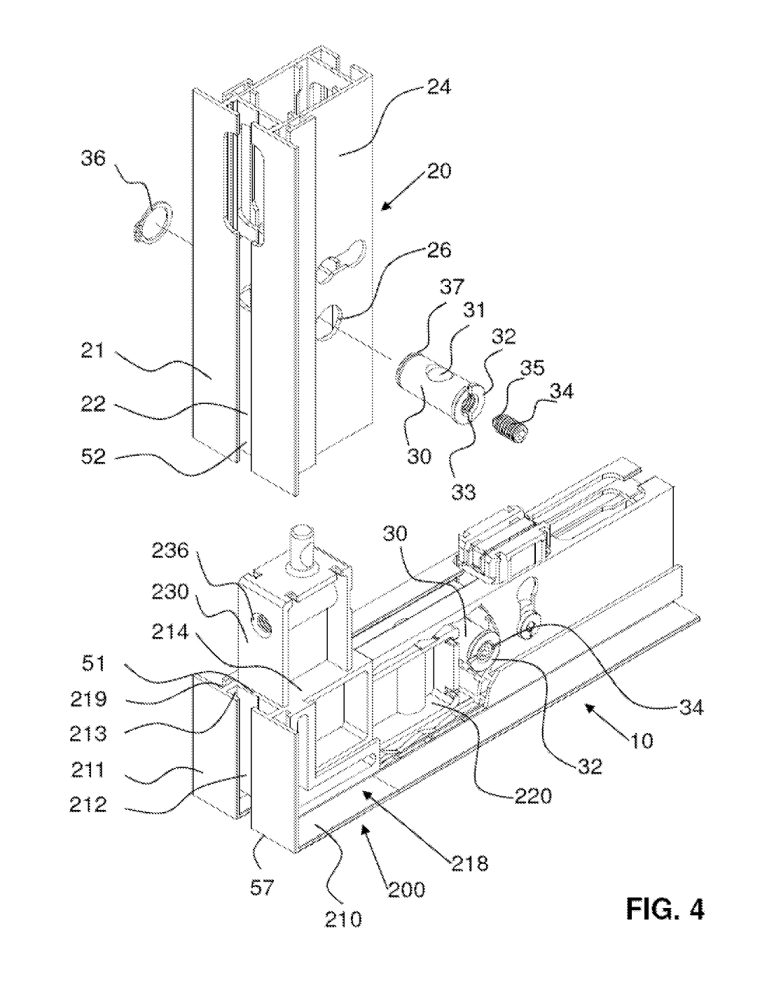

FIG. 3 shows a perspective view of the profile connector 200 according to a second exemplary embodiment of the invention, and FIG. 4 shows a perspective view of the profile connector 200 according to FIG. 3 with two profiles 10 and 20 in a manner similar to FIG. 2, in other words, in part in cross-section and in part in an exploded view. In the corner element 210, the profile connector 200 has the same characteristics as the corner element 110 of the first exemplary embodiment. The two connecting arms 220 and 230 are connected in one piece with the corner element 210 in an identical manner. In cross section, these too feature an H-shaped central body with two opposite sides 234 and a middle wall 237.

The material difference is in the design of the end surface 231, from which respectively protrudes a bolt or a pin 232 which has a conical cavity 233 on one side. This conical cavity 233 is positioned perpendicular to the arrangement of the L-shaped slot 212, that is, specifically also perpendicular to the axis of the transverse screw hole :236. For the attachment of the profiles 10 and 20, a sleeve 30 must be used with the cross bore 26 in the respective profiles 10 and 20 that are to be used, featuring a groove 37 on one of its ends, onto which a snap ring 36 can be mounted, arranged on the opposite side of the central body 24 of the supporting profile 10, 20. On what in the drawing is the front side, a flange 32 is provided with a perpendicular alignment slot 33. The alignment slot 33 is positioned parallel to the axis of the bore 31 in the sleeve 30. When the sleeve 30 is slid forward through the bore 26, the position of the alignment slot 33 can ensure that for the vertical profile 20, the bore 31 is vertically aligned, so that the bolt 232 can push through this cross bore. The cavity 233 will be approximately at the height of the inner bore of the sleeve 30, so that the second profile 20 can be attached to the profile connector 200 by way of screwing in the socket screw 34. The conical tapering 35 of the point of the socket screw head 34 that is to be screwed in acts here as a centering element in the cavity 233.

The same attachment process is used for the horizontal profile 10.

It is evident that even when no image of the exemplary embodiment is shown, it is possible to indicate an L-shaped angle connector for which on one side of a corner element 110/210 a bolt connector 220 or 230 is provided, and a locking connector 120 or 130 on the other side and on the other free end. This specifically allows for prefixing the profiles 10 and 20 such that at the two opposite free ends of a first supporting profile, the bolt connector ends 220, 230 are inserted into the central body of the profile 20 and tightened by way of respective screw rotations of the socket screws 34. These connectors are technically simpler, as they consist only of a sleeve 30, a snap ring 36, and a socket screw 34, such that connecting arms with locking ends protrude perpendicularly from the profiles 20 at the two free ends of the profile 20. Consequently, the profiles 10 with built-in locks 40 can be slid forward at to the two opposite sides until the stop, such that these profiles 10 can be tightened against the corner elements by means of a modest rotation of the eccentric locking head 44.

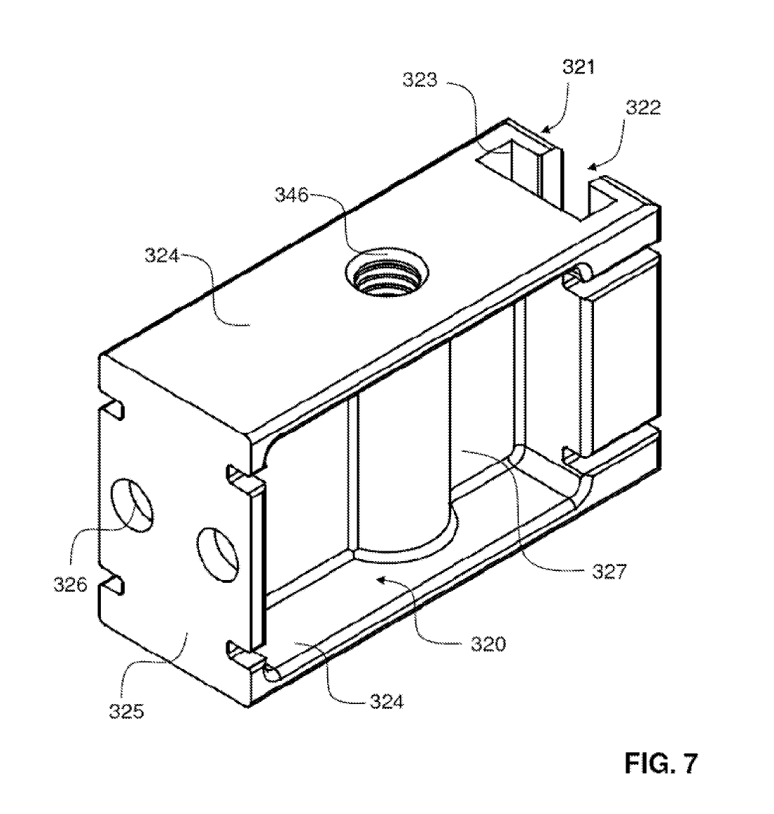

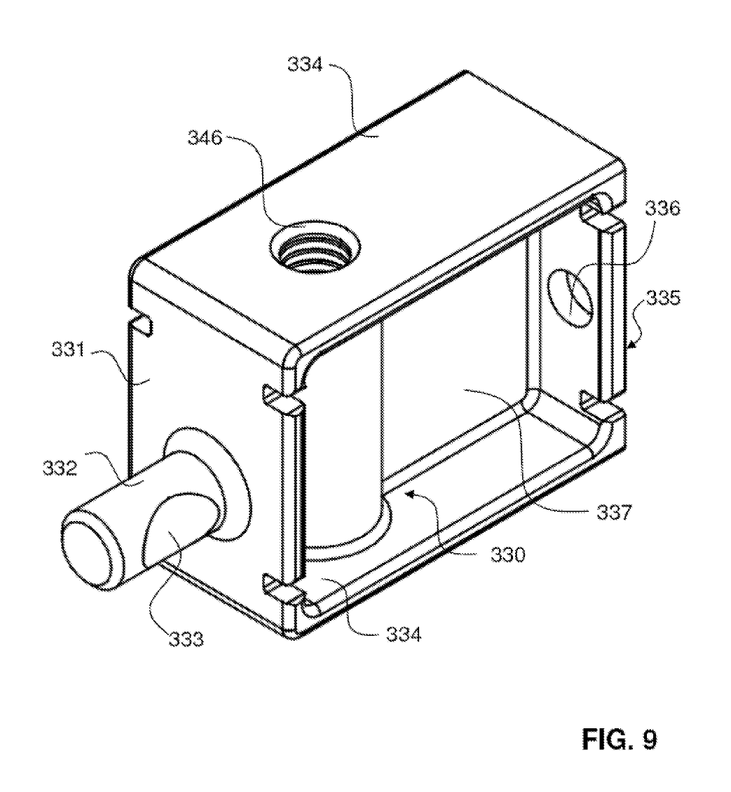

FIG. 5 shows a perspective view of the corner element 310 of a profile connector according to a third exemplary embodiment of the invention. This corner element 310 must be used together with the connecting arms providing the free ends according to the FIGS. 1 through 4. In particular, the connecting arms provided may be according to FIG. 7 or 9. The profile wall 311 is L-shaped and envelops two sides of the central body 314 of the corner connector 310, this profile wall 311 separated in the center from the profile slot 312 with the indentations 313. The slots 312 end at the side walls of the corner element 310, in which absorption cavities 315 are advantageously provided. These are arranged in the direction of the profile slot 312 on the side walls such that an edge surface 351 stays standing across from the profile slot 312. A rear wall of the central body 24 of the profile 10 or 20 that is to be mounted will push against this edge surface 351.

As in the previous exemplary embodiments of the corner connector, there is a lateral slot 318 with an indentation 319, and in cross section (for instance in a plane formed by this or that set of screw holes 316) the central body 314 features a respective H-form, since a middle wall 317 is pulled up in the middle between the side walls. Advantageously, two screw holes 316 are arranged laterally side by side in the center of the absorption cavities 315. In other exemplary embodiments, these holes may also be arranged longitudinally. Generally, two holes are provided.

The edges of the absorption cavities 315, including the edge surface 351, advantageously define the dimensions of the recess in the supporting profiles 10 and 20, with which the free ends of the corner connector are enveloped by the walls of the supporting profiles 10 and 20.

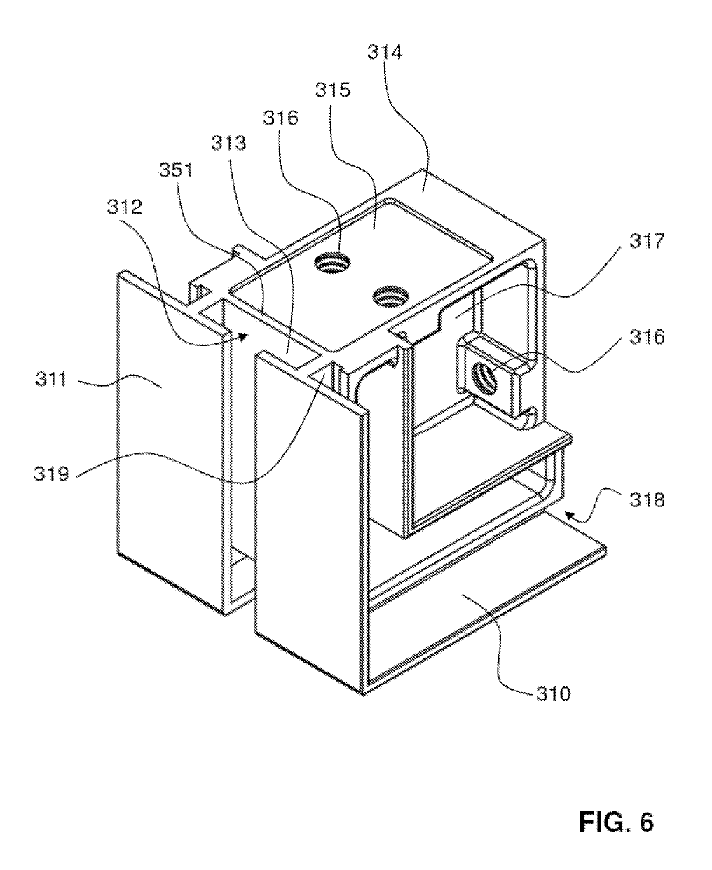

FIG. 6 shows a different perspective view of the corner element 310 according to FIG. 5, in which one can see that the screw hole 316 across from the interior space of the interior side of the body 314 has a reinforcement for a longer engagement by a respective screw. Only one screw hole 316 can be seen, since the space of the interior cavity is divided by the middle wall 317.

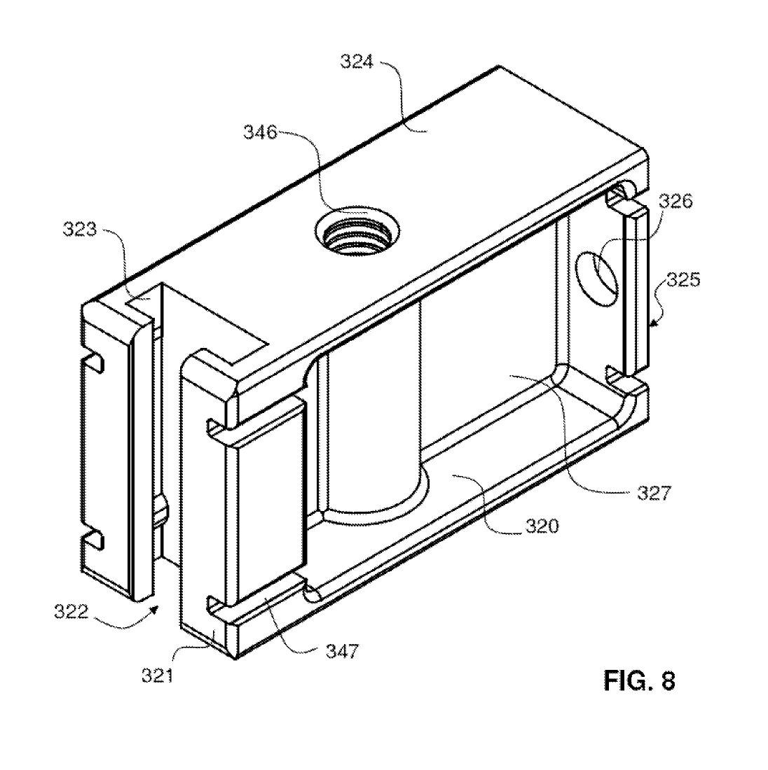

FIG. 7 shows a perspective view of a first exemplary embodiment of a connecting arm 320 of a profile connector according to a third exemplary embodiment of the invention, which can be used in combination with the corner element 310. FIG. 8 further shows a different perspective view of the connecting arm 320 according to FIG. 7. The outer form of the connecting arm 320 is cuboid. One of the end surfaces is inserted at the ends of the longer side length as a mounting surface 325 into the absorption cavity 315, such that the two passage holes 326 in the connecting arm 3:20 are positioned across from the screw holes 316 of the corner element 310. Therefore, on both sides of the centered dividing wall 327, screws can be inserted into the bore 326, such that the connecting arm 320 can be connected to the corner element 310 for using a lock.

On the one hand, the two opposing side surfaces 324 are connected to the dividing wall 327, whereas on the other hand by way of a sleeve, in which the bore 346 is provided. As in the exemplary embodiment according to the initial figures, on the opposite sides of the mounting surface 325, that is, across from the direction of the corner element 310, a profile wall 321 is provided, between which there extends a profile slot 322 which expands with an indentation 323. Profile slot 322 and screw hole 346 are aligned parallel to each other. The free end of the element must then be connected accordingly to a lock 40, provided in a profile 10 or 20.

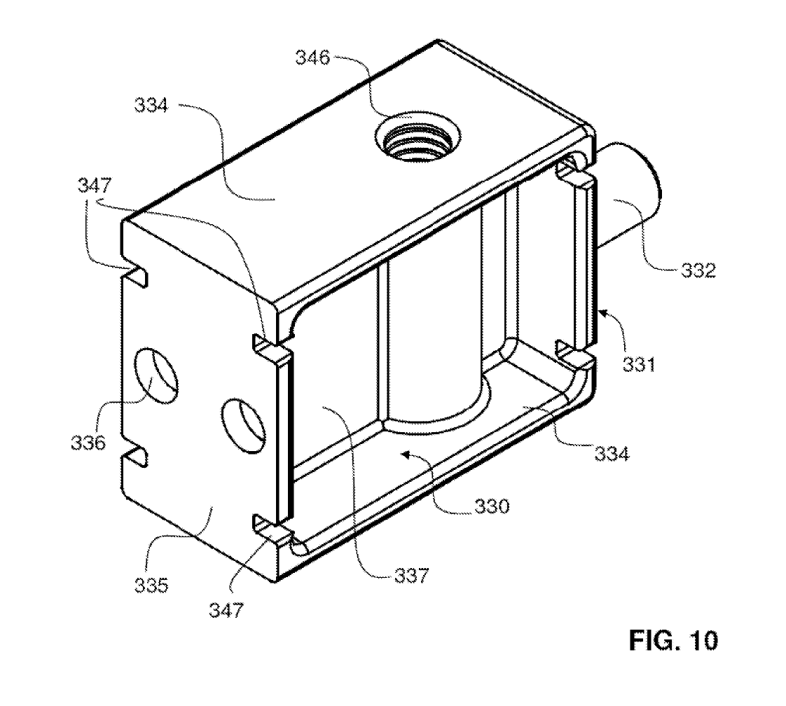

FIG. 9 shows a perspective view of an exemplary embodiment of a connecting arm 330 of a profile connector according to a third exemplary embodiment of the invention, the mounting surface 335 being intended for insertion into the absorption cavity 315, such that a screw can be inserted into the corner element 310 through the bore 336 for fixating the connector 330. FIG. 10 shows a different perspective view of the connecting arm according to FIG. 9. Here too, the two side walls 334 are separated by a sleeve with a bore 346. The pin 332 is positioned on the surface of the profile wall 331 opposite the surface 335, and the cavity 333 is arranged laterally on the outer mantle of the pin 332.

All free end connectors 320, 330 feature four intersecting grooves or slots 347 in the opposite end surfaces, here 331 and 335 in the exemplary embodiment of FIGS. 9 and 10 in the longitudinal direction of the cube. In the one-piece corner connectors 120, 130, 220, 230, the slots 347 are only provided at the free end surfaces 131, 231. These slots 347 may serve as guides is respective ribs of the supporting profiles 10, 20 extend through them.

### REFERENCE LIST

10 horizontal profile 44 eccentric locking head
19 profile protrusion 51_{—} ledge
20 vertical profile 52 rear wall of the slot
21 profile wall 55 surface
22 profile slot 56 inside edge
23 indentation 57 corner edge
24 central body 100 profile connector
26 cross bore 110 corner element
28 profile slot 111 profile wall
29 indentation 112 profile slot
30 sleeve 113 indentation
31 bore 114 central body
32 flange 115 absorption cavity
33 alignment slot 116 screw hole
34 socket screw 117 middle wall
35 conical end 118 profile slot
36 snap ring 119 indentation
37 groove 120 first connecting arm
40 lock 130 second connecting arm
131 end surface 312 profile slot
132 profile slot 313 indentation
133 indentation. 314 central body
134 side wall 315 absorption cavity
136 transverse screw hole 316 screw hole
137 middle wall. 317 middle wall
139 cavity 318 profile slot
200 profile connector 319 indentation
210 corner element 320 connecting arm for lock
211 profile wall 321 profile wall
212 profile slot 322 profile slot
213 indentation 323 indentation
214 central body 324 central body
215 absorption cavity 325 mounting surface
216 screw hole 326 bore
217 middle wall 327 middle wall
218 profile slot 330 connecting arm for screw lock
219 indentation 331 profile wall
220 first connecting arm 332 bolt
230 second connecting arm 333 cavity
231 end surface 334 central body
232 bolt 335 mounting surface
233 cavity 336 bore
234 side wall 337 middle wall
236 transverse screw hole 346 screw bore.
237 middle wall 347 slot
310 corner element 351 edge surface
311 profile wall

1-8. (canceled)

9. An angle connector for connecting a first supporting profile having a first cavity, a first outer side surface and a first active fixation element with a second supporting profile having a second cavity, a second outer side surface and a second active fixation element, wherein the angle connector comprises:
a corner element, having a first end surface and a second end surface that are aligned perpendicular to each other,
a first free end extending beyond the first end surface to be inserted into the first cavity of the first supporting profile,
a second free end aligned perpendicular to the first free end, extending beyond the second end surface and to be inserted into the second cavity of the second supporting profile, wherein the first free end of the angle connector has a first passive fixation element being complementary to the first active fixation element, wherein the second free end of the angle connector has a second passive fixation element being complementary to the second active fixation element,
wherein the first end of the angle connector can be detachably connected to the associated first supporting profile by way of the complementary first active fixation element, wherein the second end of the angle connector can be detachably connected to the associated second supporting profile by way of the complementary second active fixation element,
wherein the corner element comprises a first and a second profile element compatible with the first and second supporting profile, respectively,
wherein the first and second profile elements are provided on two outer sides of the corner element that are positioned perpendicular to each other, respectively, and
wherein the first and second profile elements of the angle connector are reaching from the corner where they meet until the height of the associated first and second end surface, respectively, of the corner element.

10. The angle connector according to claim 9, wherein the first and the second free ends of the angle connector in the portion extending over the corner element feature a body with a cuboid outer form for form-fitting absorption into a complementary recess in the associated free first and second ends of the first or second supporting profile, respectively.

11. The angle connector according to claim 10, wherein at least the first or the second free end of the angle connector forms a passive means of fixation in the form of a bolt protruding beyond the cuboid body having a cylinder mantle, comprising a conical cavity in the cylinder mantle, the bolt being associated with a sleeve with a cross bore for receiving the bolt and an inner threading at a free end of the sleeve for applying the sleeve on the respective supporting profile, such that the first or the second supporting profile can be tightened against the corner element by means of a locking screw with a conical end that can be screwed into the inner threading.

12. The angle connector according to claim 10, wherein at least one free end of the angle connector forms a passive means of fixation in the form of a locking slot with indentations formed inside the cuboid body, associated with a lock arranged in the respective supporting profile, such that locking hook of the lock engaging the indentations can be pulled back through the operation of an actuator of the lock, and the supporting profile can be tightened against the corner element.

13. The angle connector according to claim 9, wherein the first and the second free end of the angle connector are connected in one piece with the corner element.

14. An angle connector according to claim 10, wherein the corner element comprises mounting surfaces on interior sides located opposite the two perpendicular first and second outer sides, that two free end pieces are provided, of which the end surface opposite the corner element is designed for being mounted onto the associated mounting surface, and in that fixation elements are provided for connecting the corner element with the associated free end pieces.

15. The angle connector according to claim 14, wherein the mounting surfaces form a cavity for a form-fitting absorption of the end surface.

16. The angle connector according to claim 9, wherein the first and second profile elements provided at the two perpendicular first and second outer sides feature a profile wall surface and a centered slot with indentations, such that the perpendicular profile wall surfaces meet at the corner edge of the corner element.
